(19) United States
(12) Patent Application Publication
(10) Pub. No.: US 2014/0167338 A1
(43) Pub. Date: Jun. 19, 2014

(54) DEVICE FOR THE DAMPING OF IMPACTS

(71) Applicant: Florian Felix, Garmisch-Partenkirchen (DE)

(72) Inventor: Florian Felix, Garmisch-Partenkirchen (DE)

(21) Appl. No.: 14/123,549

(22) PCT Filed: Jun. 3, 2011
(86) PCT No.: PCT/EP2011/002731

§ 371 Date: Feb. 21, 2014

(51) Int. Cl. F16F 1/36

(52) U.S. Cl. CPC F16F 1/3605
USPC 267/140.11

(57) ABSTRACT

The present invention relates to a device for reducing the effect of impacts and oscillations, in particular vibrations, in particular for the damping thereof, and to the use of the device for reducing the effect of impacts and oscillations, in particular vibrations, in particular for the damping thereof.

### PRIORITY

This application is a Rule 371 national phase application of International Application No. PCT/EP2011/002731 filed Jun. 3, 2011, the contents of which are incorporated by reference herein in their entirety.

### FIELD OF THE INVENTION

The present invention relates to a device for reducing the effect of impacts and oscillations, in particular vibrations, in particular for the damping thereof and to its use.

### BACKGROUND OF THE INVENTION

To reduce, in particular damp, the effect of mechanical motions such as impacts or oscillations, damping materials or damping bodies made of damping materials are known from the prior art. In conventional damping materials the occurring reduction of the effect of mechanical motions is substantially based on two modes of action. So, elastic restoring forces in the deformation of elastic materials result in a force counteracting the affecting moving forces and thus, in a reduction of oscillations, in particular in oscillation damping. Secondly, dissipation results in an irreversible conversion of energy of motion or kinetic energy to thermal energy. Thus, by dissipation the energy of motion of the mechanical motion is reduced or absorbed and thus, the motion is damped. In particular, the force load in case of an impact is thus decreased in the damping body. In order to bring the damping material or the damping body back to its original configuration after the affect of the mechanical load in plastic materials the corresponding measures have to be taken such as coating with elastic materials that bring the damping material back to its initial shape. Alternatively, damping materials can be employed that at the same time are elastic and by themselves generate a restoring force against their deformation to establish the original shape.

Employment of viscoelastic materials such as various polyurethane foams to absorb oscillations but also for impact absorption is known in the prior art. In this context, by viscoelasticity there is understood a time, temperature, and frequency-dependent elasticity of polymers. Viscoelastic materials have both a partially elastic and partially viscous behavior. In viscoelastic polymers the viscoelasticity is in particular based on a retarded establishment of equilibrium of the macromolecules to one another.

According to the composition of the known elastomers, such as e.g., polyurethane, these are suitable for reducing the effect of either oscillations or impacts. Here, an improvement in the reduction of the effect of oscillations, for example an oscillation damping, results in a weakening of the reduction of the effect of impacts, for example an impact damping and vice versa. Here, an improvement of one property results in the weakening of the other property.

In conventional elastomers this correlation goes back to the association of elasticity and plastic deformation.

Many elastomers have a high resilience and thus, are suitable for the reduction of oscillations, for example by oscillation damping. The resilience describes the elasticity of the material after the action of forces and is determined according to DIN 53512 by determining the rebound height of a hammer falling onto a specimen of the material. Here, a high resilience (rebound elasticity) corresponds to low plastic deformation. However, low plastic deformation means low dissipation of the impact energy and thus, a weaker reduction of the effect of impacts, in particular a weaker impact damping.

As elastomers with high resilience there are known butadiene elastomers, styrene-butadiene elastomers, acrylonitrile-butadiene elastomers, isoprene elastomers, vinyl elastomers, such as EVA or EVAC, ethylene-propylene copolymer, such as EPDM, EPM, acrylic rubbers, polyisobutylene and urethane rubbers, for example. Siloxane elastomers of cross-linked polysiloxanes, such as siloxane rubbers should also be mentioned. However, these elastomers with a good resilience have only a low impact damping.

In contrast, in the prior art there are known materials distinguishing by a higher reduction of the effect of impacts. These substances, for example plastic elastomers, have an improved impact damping that is realized by a plastic deformation of the elastomer under action of forces. These polymers only slightly relax after absorption of the external force and degrade the supplied energy by internal flow processes, wherein they change their outer shape. They only get their original shape after a relatively long relaxation period in comparison to elastomers, or not at all. In contrast to the cross-linked elastomers typical materials are uncrosslinked polymers with a gel-like consistency, such as silicone gels, polyurethane gels, or uncross-linked rubber. The latter is typically not thermally cross-linked, but has few bridge-type bonds.

For example, WO 2004/022999 describes a collagen composition with good mechanical damping properties for damping a mechanical motion, in particular an impact.

However, the plastic polymers known in the prior art are disadvantageous in that they are not dimensionally stable. So, gels must be brought back to their initial shape typically with other elastic materials that restrict the gel for example in the form of a pad, in order to be able to sufficiently and effectively damp a repeated impact.

Thus, there is the need for improved devices having both a reduction of the effect of impacts, in particular by impact damping and a reduction of the effect of oscillations, in particular damping of impacts and vibrations.

### SUMMARY OF THE INVENTION

It has surprisingly been found that certain thermoplastics, namely those on the basis of styrene-butene block-copolymers, in particular styrene-isobutylene block-copolymers, are distinguished by an elastic behavior in combination with a particularly pronounced thixotropy due to the cross-linkage of the butene blocks.

Thermoplastics on the basis of styrene-butene block-copolymers in the meaning of the invention are thermoplastics containing 50 to 100% by weight, preferably 70 to 95% by weight, and particularly preferred 75 to 90% by weight of styrene-butene block-copolymers.

By thixotropy a dependency of the viscosity on the duration and height of the applied shear forces is understood. Typically, materials such as e.g., wet sand, mud, toothpaste, or hyaluronic acid exhibit thixotropic behavior. However, said materials have no significant dimensional stability in the Shore A measuring range.

In contrast, the material employed according to the invention is a thixotropic thermoplastic that is capable to dissipate the introduced impact energy by restructuring the intermolecular interactions with shape retention due to its polymer architecture. Here, the cross-linkage of the elastomeric regions in the thermoplastic simultaneously results in a restoring force. Thus, the known elastic damping property is maintained, which ensures that the material after deformation returns to its initial shape again. The thermoplastic material employed according to the invention, because of its thixotropy, while at the same being elastic, in a surprising and highly advantageous manner combines the rheological properties of gel with the elasticity of a foam or elastic rubber, respectively. According to the invention the employed thermoplastic material unlike the conventional gels does not require an elastic outer shell.

According to the invention the thermoplastic material thus can excellently be used in a device for reducing the effect of impacts and oscillations, in particular for the damping of impacts and oscillations, since it surprisingly combines the positive properties of elastic materials (strength, workability, and resilience) with the positive properties of viscoelastic and thixotropic materials.

Thus, the present invention relates to a device for reducing the effect of impacts and oscillations, in particular for the damping of impacts and oscillations, that comprises a main body (1) of a thermoplastic according to the invention on the basis of styrene-butadiene block-copolymers. The main body (1) is arranged as a top layer at least partially positive on a carrier (2) or sections of the carrier (2) or as an intermediate layer at least partially positive between sections of the first carrier (2) and the second carrier (3) .

### BRIEF DESCRIPTION OF THE FIGURES

FIG. 1 schematically represents the main body 1 as top layer on the carrier 2.

FIG. 2 schematically represents the main body 1 as intermediate layer between the first carrier 2 and the second carrier 3.

FIG. 3 schematically represents the main body 1 as intermediate layer between the first carrier 2 and the second carrier 3 that in the exemplary embodiment functions as damping member, e.g. in a grip or stick of a tool.

FIG. 4 schematically represents an example of a shovel, in the gripping element 42 of which the damping main body 1 is embedded such that no direct contact between the gripping element 42 and the shovel stick 5 is present.

FIG. 5 shows the main body 1 in a laminated composite material for the use in a ski 12. The depicted laminate in layer 11 comprises the coating and the edge of the ski, two layers of plastic-fiber composite material, such as for example glass fiber-plastic composite material (GFK) or carbon fiber-plastic composite material (CFK) 9, between which there are the main body 1 and the ski core 10 as well as the overlying top layer 8.

FIG. 6 shows the use of the invention as an external damping plate, for example for fixing on a ski 12, wherein the main body 1 is fixed on a frame plate 15 by adhesive containing layers 14.

FIG. 7 represents the schematic configuration of a trekking stick with an impact absorbing tip. The tip 16 loosely slides in the tip shell 18 and the guides 17. Here, tip 16 and stick 19 are connected by the main body 1 according to the invention.

FIG. 8 schematically represents a laminate 21 in sandwich construction, wherein the main body 1 is encompassed by two layers of a CFK composite material 9 and which is integrated in a bicycle frame 20.

FIG. 9 shows the use of the laminate 21 already described in FIG. 8 in frame 22 of a racket sports apparatus.

FIG. 10 schematically represents the cross-section of the construction of a damped racket sports racket, wherein the main body 1 according to the invention was wrapped between the racket grip 23 and the grip band 24.

FIG. 11 schematically shows as a further example a rifle at the body contact points of which, in particular at grip 26 and butt 25, the main body 1 was applied in the form of a film.

FIG. 12 schematically shows a power saw on the gripping points of which the main body 1 was applied in the form of a thin film.

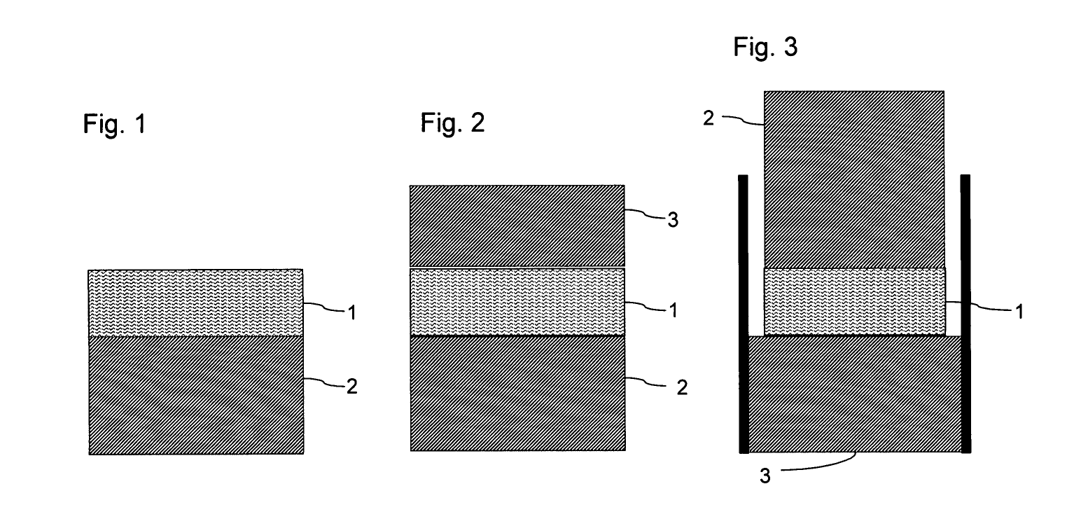

### DETAILED DESCRIPTION OF THE PREFERRED EMBODIMENTS

The thermoplastic employed according to the invention is a polymer on the basis of styrene-butene block-copolymers. Such block-copolymers are known from the prior art and can be obtained by the method described in U.S. Pat. No. 4,946,899, for example. A preferred embodiment of the invention provides the use of a thermoplastic on the basis of styrene-butadiene di-block-copolymers, in particular styrene-isobutylene di-block-copolymers. In a further advantageous development, thermoplastics on the basis of tri-block-copolymers such as styrene-butadiene-styrene tri-block-copolymers, in particular styrene-isobutylene-styrene tri-block-copolymers are used.

In the block-copolymers the butylene block, in particular the polyisobutylene block, has an average molar mass preferably of 10,000 to 200,000 g/mol, in particular 40,000 to 100,000 g/mol. Preferably, the polystyrene blocks in the block-copolymers, in particular in the tri-block-copolymer, have 5 to 50% by weight, based on the total weight of the block-copolymers. The block-copolymers may be linear, in particular linear di-block or tri-block-copolymers, respectively. Alternatively, radial block-copolymers with 3-6 arms or more, as known in the prior art, may be used.

The thermoplastic typically comprises 50 to 100% by weight, preferably 70 to 95% by weight, in particular 75 to 90% by weight of a styrene-butene block-copolymer, in particular the styrene-isobutylene block-copolymer or the styrene-isobutylene-styrene tri-block-copolymer, respectively, and 0 to 50% by weight, preferably 5 to 30% by weight, in particular 10 to 25% by weight of at least one further excipient and/or polymer, preferably polymer.

In the device for reducing the effect of impacts and oscillations, in particular for the damping of impacts and oscillations, in particular vibrations, according to the present invention the main body is applied either as top layer at least partially positive on a carrier or sections of a carrier of any shape and thus, provides a damping surface. Thus, a carrier of any shape can be protected against mechanical motions, for example impacts and oscillations, by applying the top layer of the thermoplastic according to the present invention; or impacts and oscillations applied on the carrier are transmitted to the surface in a reduced manner regarding their effect. The main body in the meaning of the invention is also referred to as a damping element. Alternatively, the main body may be provided as an intermediate layer at least partially positive between carriers or their sections to transmit impacts and oscillations acting on one carrier to the other carrier only in a reduced form, in particular damped. In this embodiment the main body thus acts as a damping member between the carriers. The connection between the main body and the carriers both as top layer and intermediate layer is realized at least partially positive, preferably adhesion resistant, for example adhesive-bonded.

In a further advantageous development of the invention the thermoplastic material is laminated and, for example integrated in a composite.

Preferably, the main body both as top layer and intermediate layer has a hardness between 25 and 70, more preferably between 30 and 60, in particular between 40 and 60 Shore hardness A (as measured according to DIN 53505).

In a preferred embodiment of the device according to the present invention the main body is formed as one piece.

In a preferred embodiment the thermoplastic in addition to the styrene-butene block-copolymer, in particular the styrene-isobutene block-copolymer or the styrene-isobutylene-styrene tri-block-copolymer, respectively, comprises a further polymer. The further polymer is preferably a resin for increasing the adhesion and cohesion forces in the thermoplastic, that is a tackifier resin, such as a tackifier resin on the basis of an aliphatic petroleum resin, a terpene-based resin, a rosin-based resin, or a DCPD (dicyclopentadienyl) based resin. Alternatively or in addition to the tackifier resin the thermoplastic in addition to the styrene-butene block-copolymer, in particular the styrene-isobutylene block-copolymer or the styrene-isobutylene-styrene tri-block-copolymer, respectively, contains a further polymer on the basis of an aliphatic olefin, in particular a polyethylene, polypropylene, or polyoctane. Further common auxiliaries or additives (e.g., stabilizing agents, etc.) may also be present.

By the use of the tackifier resin and the further polymer on the basis of an aliphatic olefin the damping properties, in particular the thixotropy of the thermoplastic can be adjusted as needed. Thus, a device for reducing the effect of impacts and oscillations, in particular for the damping of impacts and oscillations, each with custom-made properties can be obtained.

Here, the addition of a tackifier resin or oil results in a shift of the thixotropy and thus, the maximum damping towards lower or higher temperatures, according to the property profile of the resin or oil. The addition of a polymer on the basis of an aliphatic olefin typically results in a shift of the thixotropy towards higher temperatures, i.e. the maximum damping of the thermoplastic is achieved with higher temperatures.

The very good reduction of the effect of impacts and oscillations, in particular the impact and vibration damping of the device over a wide range of temperatures in particular predestines it for the use in the field of sports apparatus, in particular also in the field of winter sports.

In the devices according to the invention on the one hand the main body can be used as a damping top layer, for example in racket sports apparatus as gripping parts or frame elements for damping impacts acting on the racket main body. Thus, the vibrational transition via the racket to the hand of the player is damped, which results in an improvement of the play behavior of the racket. Thus, one embodiment provides the use of the device according to the invention in the grip or frame of a sports apparatus. Here, the grip can be the grip or frame of a racket sports apparatus, in particular a tennis, badminton, squash, racquetball, paddle, or table tennis or also baseball racket.

Moreover, the device according to the invention may be employed in cycling, in particular in the bicycle frame and in components of a bicycle, in particular the handlebar, stem, crank, pedal, grip, carrier, seat, seat post, brake lever, seat components, seat rods, perches, forks, fork supports, fixing clamps, and hubs. Here, the device can be employed both as damping top layer, for example at the handlebar grips, and as intermediate layer, for example in the bicycle frame for damping. A preferred embodiment of the device according to the invention provides a lamination of the thermoplastic in a composite material, for example in the bicycle frame.

A further embodiment according to the present invention preferably is a winter sports apparatus, in particular a ski or snowboard or sleigh and parts thereof, such as ski bindings and ski binding plates. Thus, the device can be integrated into the composite material of the ski and by damping affect the running behavior in an advantageous manner.

The device according to the invention may also be employed in leisure sports apparatus, such as walking sticks, for example trekking, hiking, Nordic Walking, tour, skating, and ski poles. A further advantageous development of the invention provides the use of the device in tools such as for example garden tool, forest tools, tools for landscape care as well as tools for construction engineering, for example shovels, rakes, rakers, saws, scissors, in particular hand shovels, spades, pruning shears, hand saws as well as power saws, wherein the device can be used both as damping top and intermediate layer. It is also advantageous to use the device according to the invention in parts of motor vehicles, in particular parts of the car body; as well as shoe cookies, for example orthopedic shoe cookies as well as fiber-reinforced soles of running shoes, cycling and walking shoes, for example.

In the devices according to the invention on the one hand the main body can be employed as a damping top layer, for example in the racket sports apparatus as gripping parts for damping impacts acting on the racket main body against the transmission to the hand. Alternatively or additionally the main body can be employed as intermediate layer, for example within the grip or grip stick to transmit only a reduced flux of force of the impact acting on the racket head to the racket grip. Accordingly, the main body can be integrated in the grip or stick of a hand tool, such as spades, a scissors, or a power saw.

The invention further relates to the use of a thermoplastic as described above on the basis of a styrene-butene block-copolymer, in particular a styrene-isobutene block-copolymer or a styrene-isobutylene-styrene tri-block-copolymer, respectively, for reducing the effect of impacts and oscillations, in particular for the damping of impacts and oscillations in a device as described above, in particular in winter sports apparatus, racket sports apparatus, bicycles, or parts thereof, leisure sports apparatus, garden tools, parts of motor vehicles, and parts of shoes, as described above.

The invention is explained in detail by the present examples.

### EXAMPLES

### Example 1

### Shovel

In conventional garden tools, such as for example shovels, when digging or loosening, the vibrations and impacts are transmitted from the shovel blade 6 via the shovel stick 5 to the gripping element 42. The user must compensate these impacts and vibrations, which results in an additional effort.

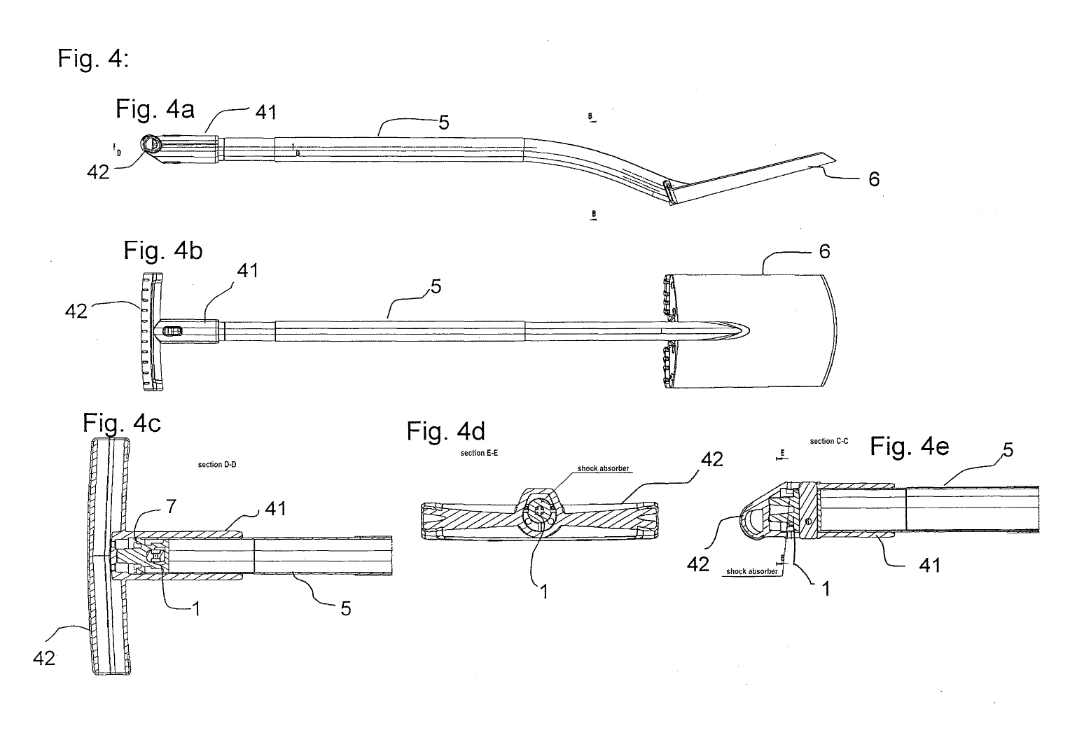

In example 1 (FIG. 4) the shovel stick 5 and the gripping element 42 are not directly connected to each other. Between the gripping element 42 and the shovel stick a grip shell 41 is placed. In the grip shell 41 the shovel stick 5 contacts the main body 1 according to the invention that thus is restricted by the gripping element 42 and the shovel stick 5 (FIG. 4c). According to the invention, the main body damps the impacts and vibrations, so that these are not or only in an attenuated form transmitted to the gripping element 42 and thus, also to the user. Here, the maximum damping is restricted by the locking elements 7.

In said example the use of the main body 1 according to the invention results in a higher power saving in working with the tool in comparison with conventional shovels.

### Example 2

### Ski with Internal Damping

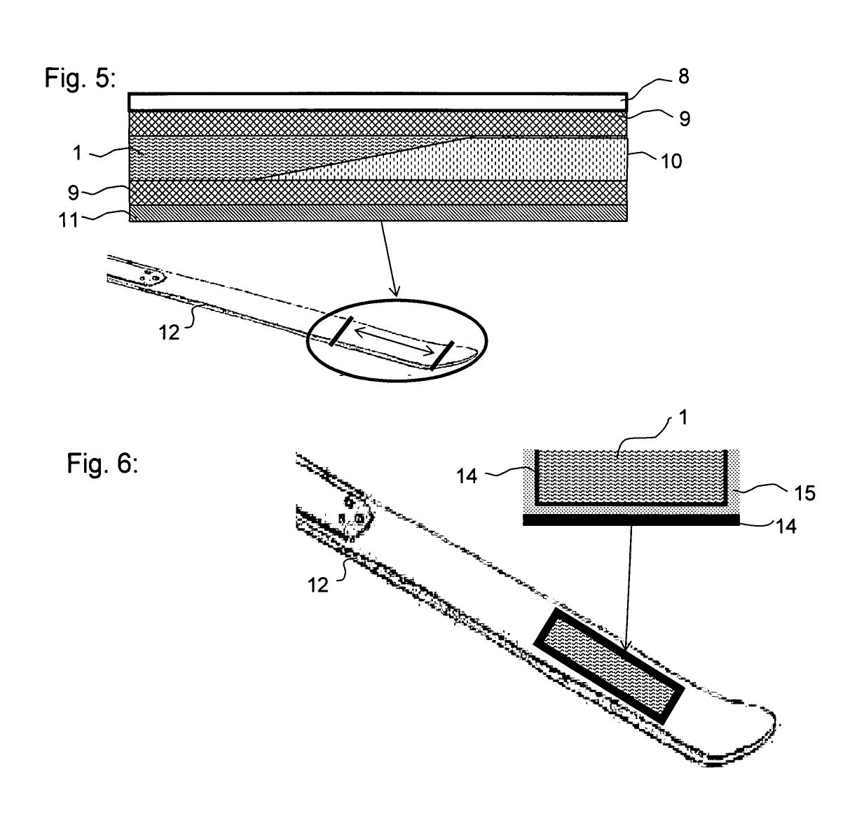

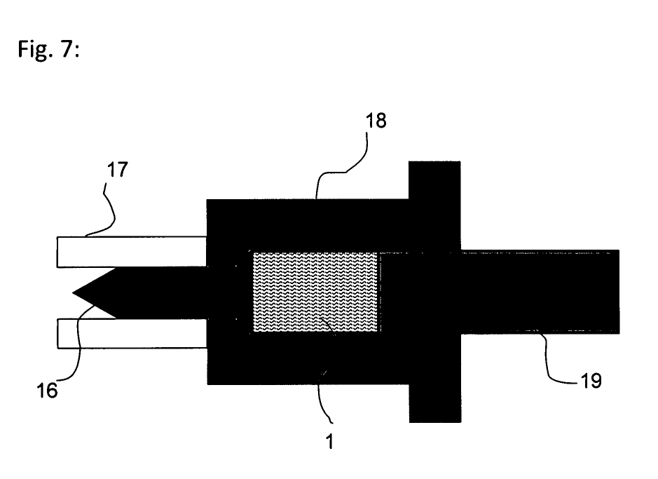

In the second example, a damped ski, the main body 1 according to FIG. 5 is locally laminated into the ski 12. At these points of the ski 12 the laminate consists of a layer 11 forming coating and edge of the ski and a layer of GFK and/or CFK composite material 9. On this follows the main body 1 that at the corresponding point replaces the wood or polyurethane core 10 and/or overlaps with it. The subsequent layer is formed by the composite material 9 which is followed by a printed topsheet as uppermost layer. Preferably, the main body 1 according to the invention is inserted between tip and core tip of the ski 12 in an overlapping manner. In a direct comparison with a conventional ski it can be shown that laminating the main body 1 hinders the vibrations occurring when driving from running on to the binding area. For that, test drivers drove with a ski each with and without the construction according to the invention. This has a markedly positive effect on the running behavior of the ski. So, it is smoother and easier to control which results in a significantly more comfortable driving experience.

### Example 3

### Ski with External Damping

According to FIG. 6A, at first a main body 1 is fixed on a frame plate 15 with adhesive containing layers 14. The thus prepared frame plate 15 is glued on the ski 12 in the front area of the ski 12 between tip and core tip. Also in this example, in analogy to the second example, a markedly smoother running behavior can be observed that is easier to control.

### Example 4

### Trekking Stick

In trekking sticks the vibrations and impacts generated when putting the stick on the ground are transmitted to the runner resulting in an increased effort and decreasing the comfort. Trekking sticks with a shock-absorbing tip often have a tip shell 18 with guides 17 in which the tip 16 loosely slides. Between the tip 16 and the end of the trekking stick 19 there is damping material, in the example the main body 1. With the depicted construction various materials such as silicone, thermoplastic elastomers as well as the thermoplastic according to the invention have been tested. With respect to the vibration damping the construction with the thermoplastic according to the invention is clearly superior to the other tested materials.

### Example 5

### Bicycle

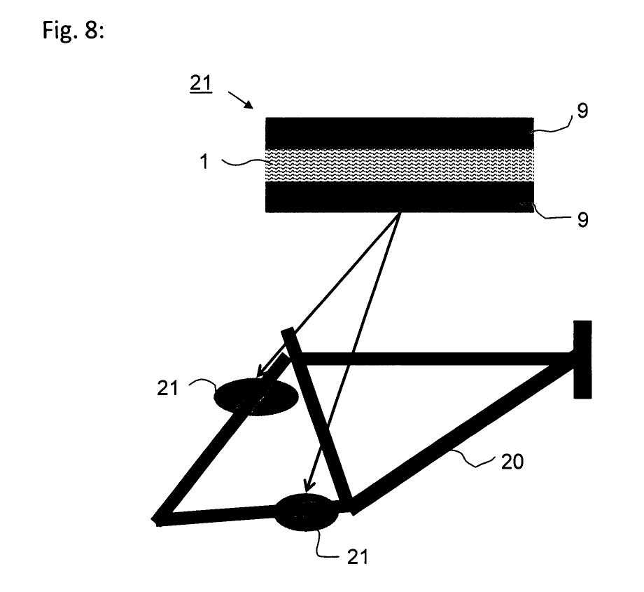

The main body 1 was laminated between CFK layers 9. The thus formed laminate 21 therefore is a constituent of the bicycle frame 20. FIG. 8 shows the preferable fitting positions in which the laminate 21 particularly advantageous acts on the comfort gain. By the partial laminate 21 both vibrations in the saddle and in the entire bicycle can be markedly decreased.

### Example 6

### Tennis Racket

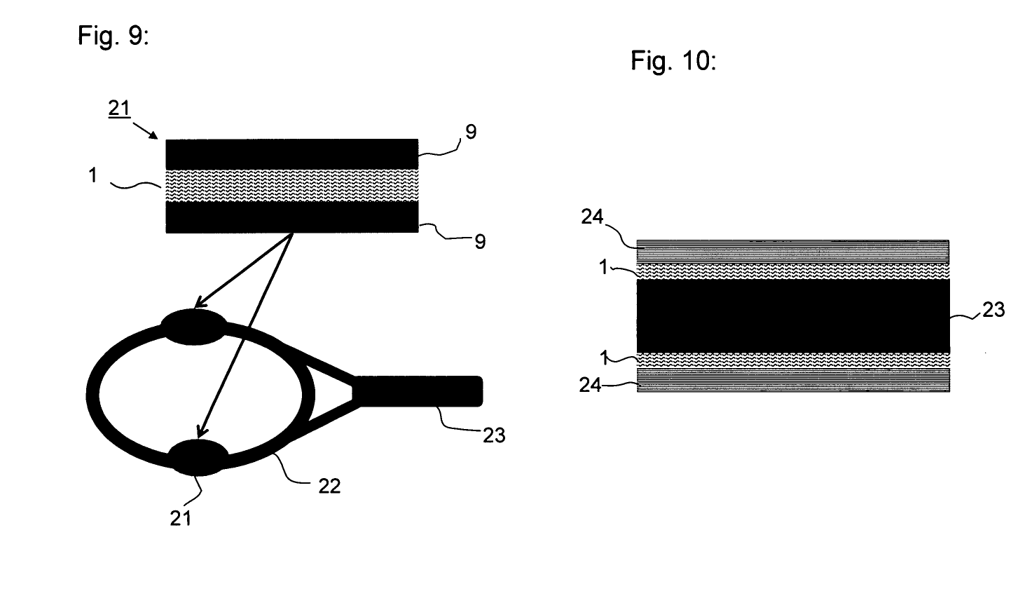

According to the preceding example the main body 1 was laminated between the CFK layers 9 of the frame 22 of a tennis racket (FIG. 9). This results in a considerable reduction of the vibrations upon the impact of the ball and thus, crucially acts positively on the play behavior.

### Example 7

### Racket Grip

In a further example the main body 1 according to the invention was wrapped between the racket grip 23 and the grip band 24 (FIG. 10). As described in example 6, also here the vibrations were markedly reduced and the comfort as well as the play behavior were significantly improved in comparison with a conventional racket.

### Example 8

### Rifle

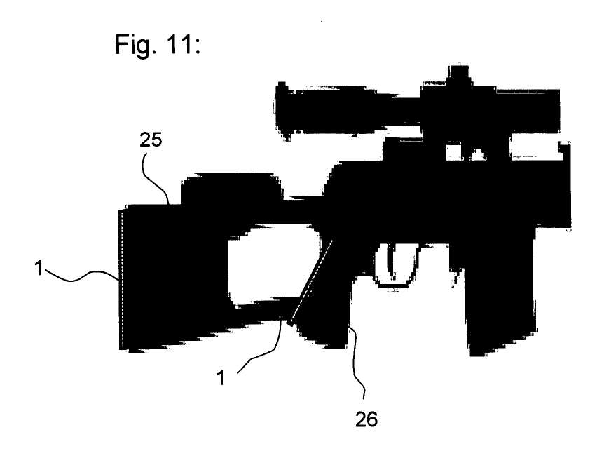

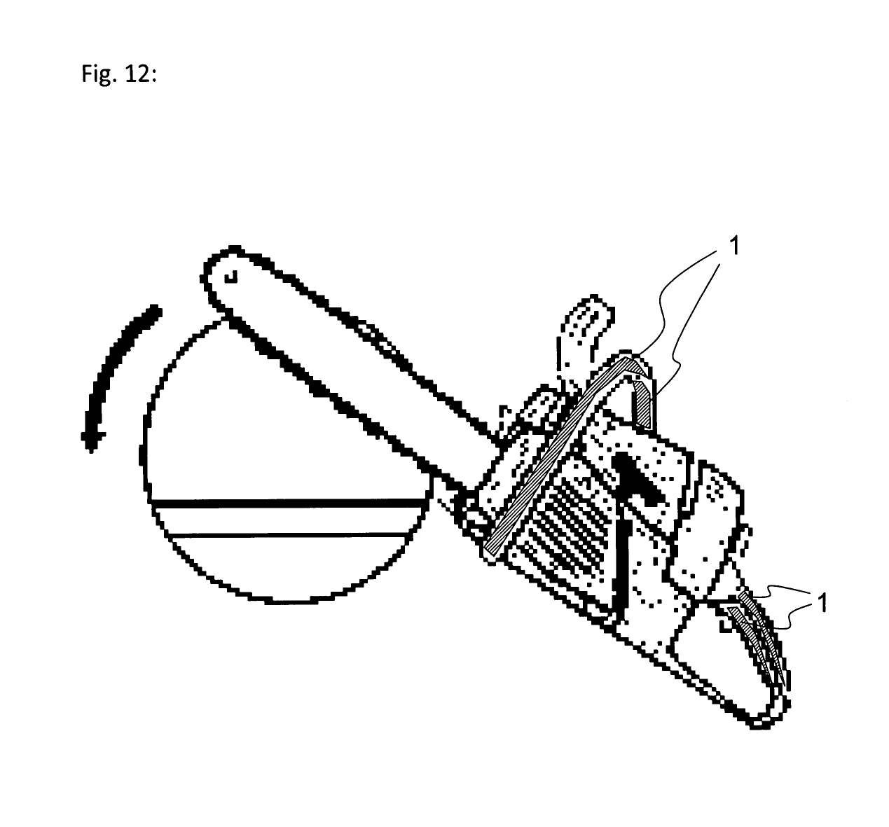

According to FIG. 11 the main body 1 was glued as a thin film onto the body contact points, in particular at the grip 26 and the butt 25. Despite the low thickness of the film of 1 mm a markedly reduction of the recoil effect on the body can be observed which results in a markedly increased shooting comfort.

### Example 9

### Power Saw

In analogy to example 8 a thin film of the main body was glued on the holding points of the power saw. Also here, power savings were achieved by reducing vibrations.

1. A device for reducing the effect of impacts and oscillations, wherein said device comprises a main body (1) comprised of a thermoplastic material based on a styrene-butene block-copolymer, further wherein the main body (1) is either (a) arranged as a top layer at least partially positive on a section of a first carrier (2), or (b) arranged as an intermediate layer at least partially positive between sections of a first carrier (2) and a second carrier (3).

2. The device according to claim 1, wherein the thermoplastic material has a hardness between 25 and 70 Shore hardness A.

3. The device according to claim 1, wherein the main body (1) is formed as one piece.

4. The device according to claim 1, wherein the main body (1) is adhesively connected to said first carrier (2) and/or said second carrier (3).

5. The device according to claim 1, wherein the main body (1) forms a laminate with said first carrier (2) and said second carrier (3).

6. The device according to claim 1, wherein the thermoplastic material is based on a styrene-isobutylene block-copolymer.

7. The device according to claim 1, wherein the thermoplastic material is based on a styrene-isobutylene-styrene tri-block-copolymer.

8. The device according to claim 1, wherein the thermoplastic material contains at least one further polymer.

9. The device according to claim 7, wherein the further polymer comprises a tackifier resin or oil.

10. The device according to claim 8, wherein the tackifier resin is selected from the group consisting of an aliphatic petroleum resin, a terpene-based resin, a rosin-based resin, a DCPD-based resin and mixtures thereof.

11. The device according to claim 1, wherein the thermoplastic material contains at least one further polymer on the basis of an aliphatic olefin.

12. The device according to claim 1, wherein said device is a winter sports apparatus, a racket sports apparatus, a bicycle or a part thereof, a leisure sports apparatus, a garden tool, a part of a motor vehicle, or a shoe cookie.

13. (canceled)

14. The device according to claim 12, wherein said device comprises a frame of a bicycle.

15. The device according to claim 12, wherein said device comprises an accessory or component of a bicycle selected from the group consisting of a handlebar, stem, crank, pedal, grip, carrier, seat, and seat post.

16. The device according to claim 1, wherein said device dampens vibrations.

17. The device according to claim 1, wherein said aliphatic olefin comprises polyethylene or polypropylene.

18. The device according to claim 12, wherein said device is a winter sports apparatus selected from the group consisting of a ski, snowboard, a slight, and a bob, and parts thereof.

19. The device according to claim 12, wherein said device is a racket sports apparatus selected from the group consisting of a tennis, badminton, squash, racquetball, paddle, table tennis, and baseball racket.

20. The device according to claim 12, wherein said device is a leisure sports apparatus selected from the group consisting of a walking stick and ski stick.

21. The device according to claim 12, wherein said device is a garden tool selected from the group consisting of a shovel, scissors, saw, and power saw.
